(19) United States
(12) Patent Application Publication
(10) Pub. No.: US 2013/0263790 A1
(43) Pub. Date: Oct. 10, 2013

(54) Feline Litter Apparatus

(71) Applicant: William J. Stange, Shoshoni, WY (US)

(72) Inventor: William J. Stange, Shoshoni, WY (US)

(21) Appl. No.: 13/847,807

(22) Filed: Mar. 20, 2013

Related U.S. Application Data
(60) Provisional application No. 61/620,044, filed on Apr. 4, 2012.

(51) Int. Cl. A01K 1/01

(52) U.S. Cl. CPC A01K 1/0107
USPC 119/165

(57) ABSTRACT

A feline litter apparatus that is attachable to the exterior of a house and accessible to a cat includes a housing having a bottom wall with outer, inner, and side walls extending upwardly from the bottom wall in a manner that defines an interior area and open top. A lid is pivotally coupled to the inner wall and movable between open and closed configurations.

The inner wall includes a knockout panel surrounded by lines of weakness, whereby the at least one knockout panel is selectively removable such that the inner wall defines an entry opening. The housing may be attached to the exterior of a house such that the inner wall is in communication with an interior of the house so that a cat able to enter into the housing interior area and use a litter box situated therein.

### REFERENCE TO RELATED APPLICATIONS

This non-provisional patent application claims the benefit of provisional application Ser. No. 61/620,044 filed on Apr. 4, 2012, titled Litter House.

### BACKGROUND OF THE INVENTION

This invention relates generally to animal litter boxes and, more particularly, to a litter apparatus that houses a litter box outside of a building and that enables a cat to move freely between the building and the litter box while substantially keeping litter odor out of the building.

Litter boxes are traditionally situated inside a house to enable a cat to urinate or defecate in a natural environment yet without making a mess on the carpet or floor. Unfortunately, the smell of cat waste is undesirable, even when buried or mixed with the litter granules. Many people try to conceal their cat's litter box in their homes, but the scent of cat urine and feces can waft through the rooms near the litter box. To prevent this from happening, some cat owners may clean out the litter box more often than necessary, which can be time consuming. Additionally, cleaning up a cat's litter box can be messy, and the litter can scatter throughout the home. Small children may try to play in the litter box if he or she doesn't understand what it's used for. Small children or other animals may even eat the litter or waste, which can spread a wide variety of germs.

Therefore, it would be desirable if the litter box could be situated outside of a residence so as to avoid the disadvantage of having litter odors spread throughout the home yet be easily accessible by cats needing to access the litter box.

### SUMMARY OF THE INVENTION

A litter apparatus according to the present invention includes an outdoor structure having a hinged top and a sloping roof for rain drainage that can be opened by a user to remove a standard cat litter box stored therein. The apparatus mounts to the side of a building, such as a house, and includes one or more knockout panels for a swinging cat door that permit a cat to enter into the interior area of the device. The roof additionally includes a lockable latch to prevent a cat from getting out. This device provides homeowners with a way to isolate their cat's litter box from the rest of the home without making it difficult for the cat to access it. Users may keep the smell and messes associated with cat litter outside of the home while still keeping his or her pet inside. In addition, the present invention enables a user to clean up and change the litter outside.

Therefore, a general object of this invention is to provide a feline litter apparatus that includes a housing that may be mounted to the exterior of a house that enables a cat to walk from the house into the housing and use a litter box.

Another object of this invention is to provide a feline litter apparatus, as aforesaid, that allows the litter box to be changed from outside of the house.

Still another object of this invention is to provide a feline litter apparatus, as aforesaid, that substantially maintains the odor of litter box inside the housing and out of the interior of the house.

Yet another object of this invention is to provide a feline litter apparatus, as aforesaid, that is easy for a cat to access from inside the house and which is easy for a user to access from outside the house.

A further object of this invention is to provide a feline litter apparatus, as aforesaid, that is easy for a user to install securely to the side of a house.

Other objects and advantages of the present invention will become apparent from the following description taken in connection with the accompanying drawings, wherein is set forth by way of illustration and example, embodiments of this invention.

### BRIEF DESCRIPTION OF THE DRAWINGS

FIG. 1 is a perspective view of a feline litter apparatus according to a preferred embodiment of the invention with the lid in a closed configuration;

FIG. 2 is a perspective view of the litter apparatus as in FIG. 1 with the lid in an open configuration;

FIG. 3 is a perspective view of the litter apparatus as in FIG. 1 shown mounted to a house;

FIG. 4 is a rear view of the housing shown with one knock-out panel removed; and

FIG. 5 is an exploded view of the litter apparatus.

### DESCRIPTION OF THE PREFERRED EMBODIMENT

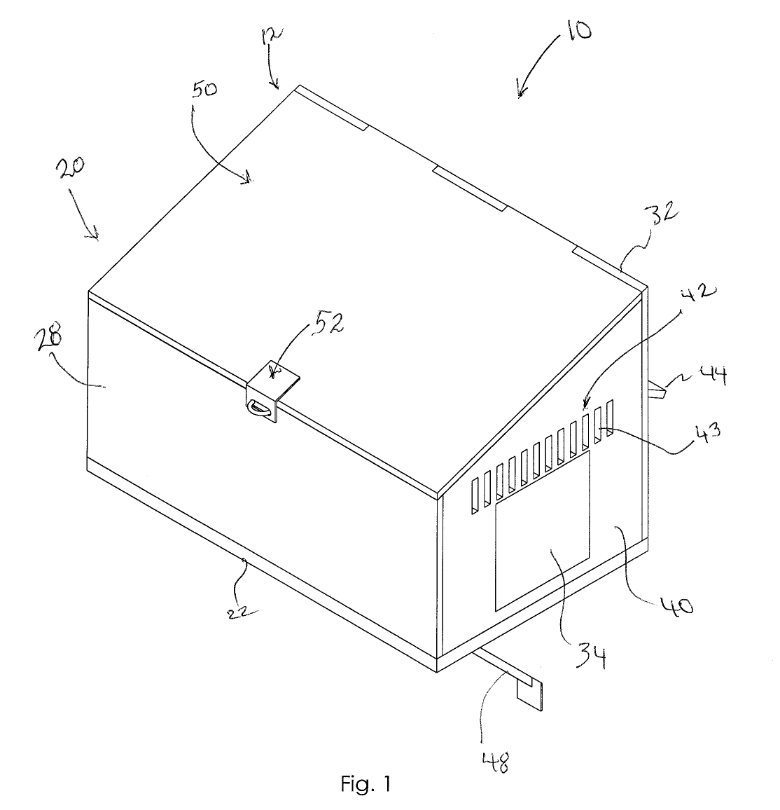

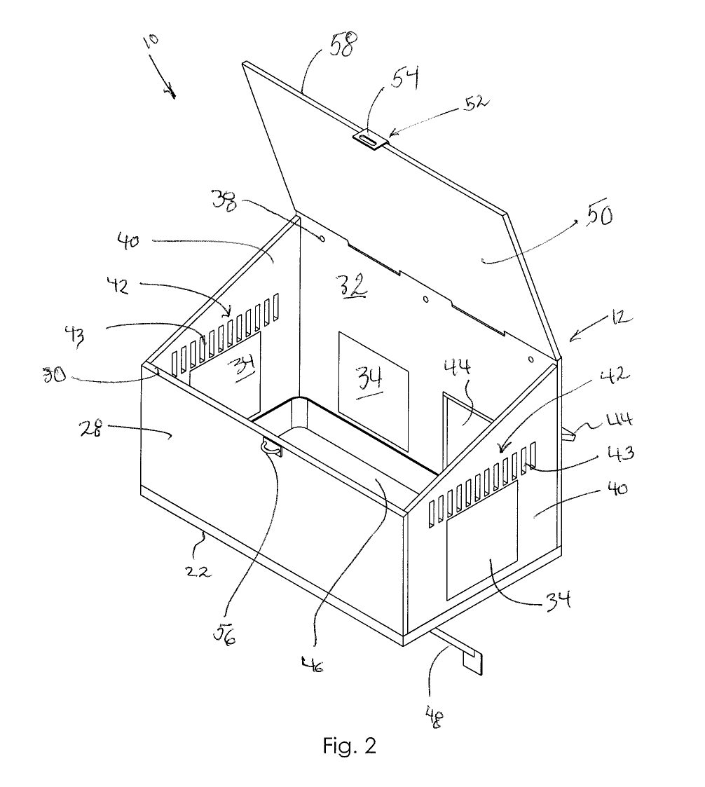

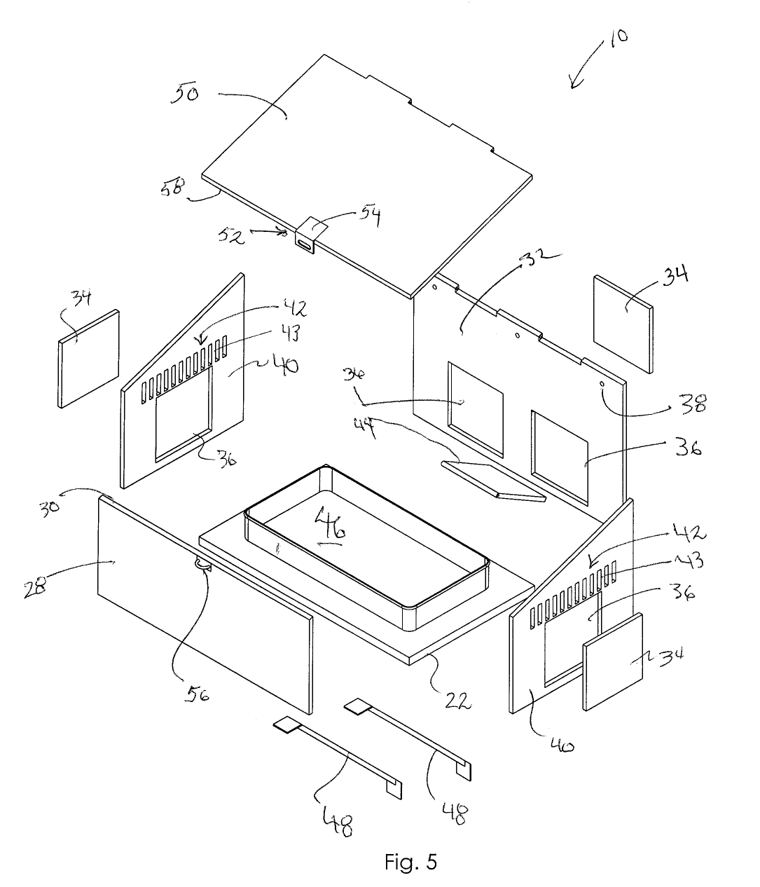

A feline litter apparatus according to a preferred embodiment of the present invention will now be described with reference to FIGS. 1 to 5 of the accompanying drawings.

The feline litter apparatus 10 (also referred to simply as the “litter apparatus”) includes a housing 20 having a bottom wall 22 with upstanding walls extending upwardly from perimeter edges thereof. The bottom wall 22 includes a generally planar configuration having upper 24 and lower 26 surfaces. An outer wall 28 extends upwardly from an outer edge of the bottom wall 22, the outer wall 28 extending longitudinally between ends of the bottom wall 22. An inner wall 32 extends upwardly from an inner edge of the bottom wall, the inner wall 32 extending longitudinally between ends of the bottom wall 22. The inner and outer walls are situated along opposite sides of the bottom wall 22 and are generally parallel to one another. The inner wall 32 has a height that is greater than a height of the outer wall 28 for reasons that will be described in further detail later.

A pair of opposed side walls 40 extend upwardly from opposed ends of the bottom wall 22. The side walls 40 also extend between respective ends of the inner wall 32 and outer wall 28. Together, the bottom wall 22, inner wall 32, and outer wall 28 define an interior area of the housing 20, the housing 20 having an open top. A litter box 46 may be situated in the interior area and supported upon the upper surface 24 of the bottom wall 22.

A lid 50 is pivotally coupled along an inner edge to an upper edge of the inner wall 32, such as with hinges, and is pivotally movable between an open configuration allowing access to the interior area of the housing 20 and a closed configuration not allowing access to the interior area. As will be described later, a user may access a litter box 46 within the housing interior area when the lid 50 is in the open configuration. The lid 50 includes a front edge 58 that rests upon an upper edge 30 of the outer wall 28 when the lid 50 is at the closed configuration (FIG. 1). The lid 50 includes an upper surface that is water resistant and has a durable construction that is capable of withstanding rain and other harsh weather elements such as wind, rain, ice, snow, and the like. The inner wall 32 may include a height that is greater than a height of the outer wall 28 such that the lid 50 is sloped downwardly from the inner wall 32 toward the outer wall 28 so that rain will flow away from the side of the house to which the housing 20 is mounted.

The lid 50 includes a fastener 52 having a first portion 54 situated proximate the front edge 58 of the lid 50 and a second portion 56 situated proximate the upper edge 30 of the outer wall 28. The first and second portions of the fastener 52 may be selectively coupled together so as to releasably secure the lid 50 at the closed configuration (FIG. 1). The fastener 52 may be a clasp, buckle, magnetic closure, or other suitable fastener. The fastener 52 may include a lock (not shown).

The inner wall 32 of the housing 20 includes at least one “knockout panel” 34 having a plurality of perforations or lines of weakness such that the panel 34 may be selectively removed by a user exerting a predetermined amount of pressure against it. When a panel is removed, the inner wall 32 defines an entry opening 36 through which a cat may pass. Similarly, the side walls 40 may also include a knockout panel 34 and corresponding entry opening 36. It is noted that all of the knockout panels and entry openings are referred to by the same respective reference numerals.

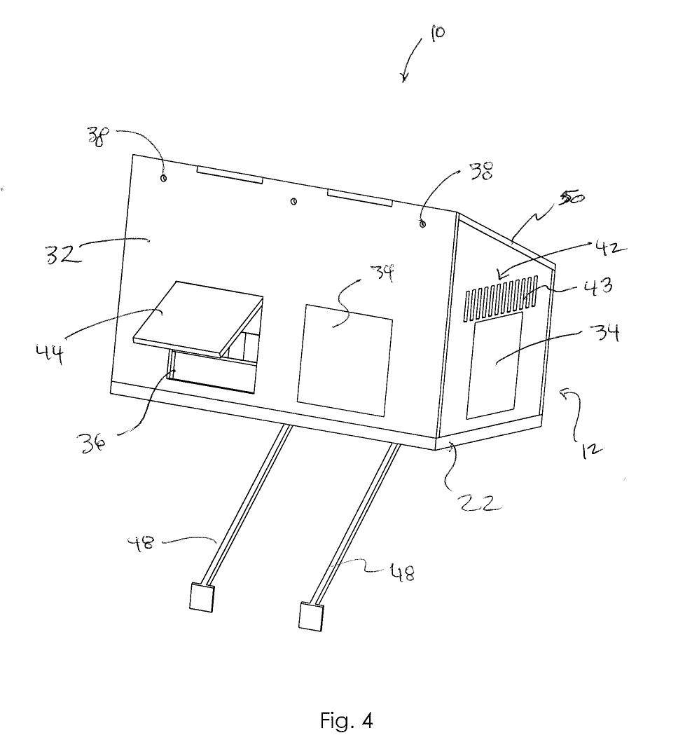

A swingable access door 44 may be pivotally mounted to the inner wall 32 surrounding a respective entry opening 36 once a respective knockout panel 34 has been removed (FIG. 4). The access door 44 is selectively and pivotally movable between a closed configuration blocking access through the respective entry opening 36 and an open configuration allowing access through the respective entry opening 36. In one embodiment, the access door 44 may be biased toward the closed configuration, either by the force of gravity or even with a spring (not shown).

In one embodiment, each side wall 40 of the housing 20 includes a vent member 42 having a plurality of spaced apart apertures 43. The apertures 43 may be in the form of slots although an arrangement such as spaced apart holes would also work. The apertures 43 are configured to circulate undesirable odors out of the interior area of the housing and to enable fresh air from outside of the housing to enter therein.

The inner wall 32 may also include a plurality of fastener ports 38 spaced apart along the upper edge 33 thereof. Each fastener port 38 is configured to receive a fastener, each fastener being configured to extend from the interior area through the port 38 and into the wall of a building structure such as a house. Suitable fasteners for insertion through the fastener ports include screws, bolts, nails, or the like. Accordingly, the housing 20 is configured to be mounted to a house. It is also understood that an appropriate passage opening must be cut out of a wall of the house that is aligned and configured to match a respective entry opening so that a cat may pass into or out of the interior area of the housing 20.

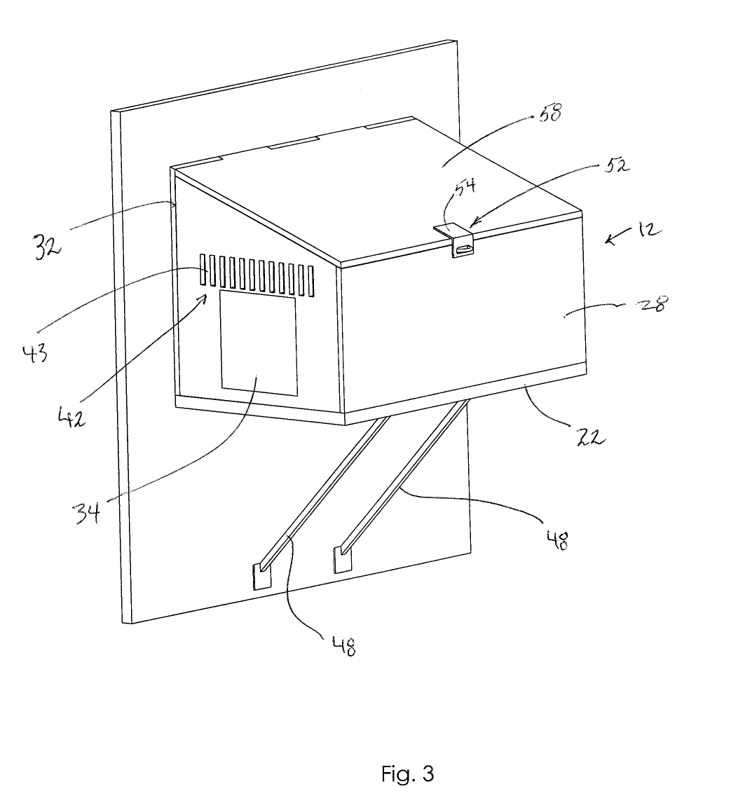

At least one mounting bracket 48 may be coupled to a lower surface of the bottom wall 22 of the housing 20 and configured to support the weight of the housing 20 when mounted to the wall of a house or other structure. Preferably, the apparatus 10 includes a pair of brackets. Each bracket 48 has a proximal end coupled to the bottom wall 22 and an opposed distal end configured to be coupled to the wall of the building structure (FIG. 3).

Preferably, the proximal end is positioned adjacent the outer wall 28 of the housing and the bracket extends downwardly and inwardly in the direction toward the inner wall 32.

In use, the kitty litter apparatus 10 may be mounted to the exterior side of a house or other building structure as described above. Specifically, the inner wall 32 of the housing 20 may be attached to a house wall with fasteners inserted through the fastener ports 38. Access to the fastener ports 38 may be had by raising the lid 50 to the open configuration. Prior to mounting the housing 20, a knockout panel 34 may be removed and the access door 44 mounted to a respective entry opening 36. An access opening in the wall of the house may also be made prior to mounting the housing 20 and such that the entry opening 36 is selectively accessible from inside the house. A litter box 46 may be prepared and placed upon the bottom wall 22 inside the interior area. From inside the house, a cat will then be free to enter into the interior area of the housing 20 to use the litter box 46 and then to return into the house. The swingable access door 44 is biased to return to the closed configuration and, therefore, keep the odor inside the interior area or until it may be naturally exhausted through the vent apertures 43.

It is understood that while certain forms of this invention have been illustrated and described, it is not limited thereto except insofar as such limitations are included in the following claims and allowable functional equivalents thereof. CLAIMS

1. A feline litter apparatus attachable to an exterior of a house and accessible to a cat inside the house, comprising:
a bottom wall;
an outer wall extending upwardly from said bottom wall;
an inner wall extending upwardly from said bottom wall, said inner wall being displaced and generally parallel to said outer wall;
a pair of opposed side walls extending upwardly from said bottom wall and extending between ends of said interior and outer walls, respectively;
wherein said bottom wall, said outer wall, said inner wall, and said pair of side walls together define an interior area;
a lid pivotally coupled to said inner wall and selectively movable between an open configuration allowing access to said interior area and a closed configuration not allowing excess to said interior area;
wherein said inner wall includes at least one knockout panel surrounded by lines of weakness, whereby said at least one knockout panel is selectively removable when a predetermined force is applied thereto such that said inner wall defines an entry opening when at least one knockout panel is removed.

2. The apparatus as in claim 1, further comprising a litter box situated on said bottom wall in said interior area.

3. The apparatus as in claim 1, wherein said lid includes:
a first edge that rests upon an upper edge of said outer wall when said lid 50 is at said closed configuration;
a fastener having a first portion situated proximate said first edge of said lid and a second portion situated proximate said upper edge of said outer wall, said first and second portions being configured to selectively and releasably hold said lid at said closed configuration.

4. The apparatus as in claim 1, further comprising a swingable access door pivotally coupled to said inner wall so as to cover said entry opening when a respective knockout panel is selectively removed from inner wall, said swingable access door being movable between an closed configuration blocking passage through said entry opening and an open configuration allowing passage through said entry opening.

5. The apparatus as in claim 4, wherein said swingable access door is biased toward said closed configuration.

6. The apparatus as in claim 1, wherein said lid includes an upper surface that is water resistant and constructed to withstand harsh weather conditions.

7. The apparatus as in claim 1, wherein each side wall includes a vent member, said vent member including a plurality of spaced apart apertures configured to circulate undesirable odors out of said interior area.

8. The apparatus as in claim 1, wherein each side member includes a side wall knockout panel surrounded by lines of weakness, whereby said at least one side wall knockout panel is selectively removable when a predetermined force is applied thereto such that said each side member defines a side member entry opening when at least one side wall knockout panel is removed.

9. The apparatus as in claim 8, further comprising a swingable side wall access door pivotally coupled to respective side walls so as to cover respective side wall entry openings when respective knockout panels are selectively removed from said respective side walls, each swingable side wall access door being movable between a closed configuration blocking passage through said respective side wall entry openings and an open configuration allowing passage through said respective side wall entry openings.

10. The apparatus as in claim 4, wherein each side wall swingable access door is biased toward said closed configuration.

11. The apparatus as in claim 1, wherein said inner wall defines a plurality of fastener ports adjacent an upper edge, said plurality of fastener ports configured to receive mounting fasteners configured to mount said inner wall to the house.

12. The apparatus as in claim 1, further comprising at least one mounting bracket coupled to a lower surface of said bottom wall adjacent a front edge thereof and extending to an exterior surface of the house, said at least one mounting bracket configured to support the weight of said apparatus.

13. The apparatus as in claim 1, wherein said inner wall includes a height that is greater than a height of said outer wall such that said lid is sloped downwardly from said inner wall to said outer wall, said outwardly sloped lid causing rain to flow away from the house.
